(19) United States
(12) Patent Application Publication
(10) Pub. No.: US 2010/0079015 A1
(43) Pub. Date: Apr. 1, 2010

(54) DUST CORE, METHOD FOR PRODUCING THE SAME, ELECTRIC MOTOR, AND REACTOR

(76) Inventors: Eisuke Hoshina, Toyota-shi (JP); Toshiya Yamaguchi, Nishikamo-gun (JP); Yusuke Oishi, Nagoya-shi (JP); Junghwan Hwang, Nisshin-shi (JP); Kazuhiro Kawashima, Kasugai-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/532,759

(22) PCT Filed: Apr. 18, 2008
(86) PCT No.: PCT/JP2008/058000

§ 371 Date: Sep. 23, 2009

(30) Foreign Application Priority Data
Apr. 20, 2007 (JP) 2007-111739

(51) Int. Cl. H01F 1/28; B29C 70/00; H02K 15/12; H01F 27/255

(52) U.S. Cl. 310/44; 264/241; 252/62.53; 336/233

(57) ABSTRACT

According to the present invention, a dust core having excellent insulating properties, high strength, and high density (high magnetic flux density), a method for producing the same, and an electric motor or reactor having a core member composed of the dust core are provided. Therefore, a method for producing a dust core is provided, such method comprising the following steps: a 1^{st} step of preparing a resin powder 2 and a magnetic powder 1 comprising soft magnetic metal powder (pure iron powder 11) particles each having an insulating film (silica film 12) preliminarily formed on the surface thereof; a 2^{nd} step of obtaining a powder mixture by mixing the magnetic powder 1 and the resin powder 2; and a 3^{rd} step of allowing the resin powder 2 to gel in an atmosphere at a certain temperature, press-molding the powder mixture so as to obtain a press molded body 10, and annealing the press molded body 10 so as to produce a dust core 20.

### TECHNICAL FIELD

The present invention relates to a dust core, a method for producing the same, and an electric motor and a reactor each having a core member composed of the dust core.

### BACKGROUND ART

In view of reducing environmental burdens, the development of hybrid vehicles and electric vehicles has been conducted day by day in the automobile industry. In particular, one urgent development objective is to realize a high-performance and downsized motor or reactor, which is a main apparatus mounted on vehicles.

A stator core or a rotor core, which constitutes a motor, and a reactor core, which constitutes a reactor, are each composed of a steel sheet laminate in which silicon steel sheets are laminated or of a dust core obtained via press molding of a resin-coated iron-based soft magnetic powder. A variety of cores formed with dust cores are advantageous in terms of magnetic properties that result in lower high-frequency iron loss than in the case in which laminated steel sheets are used, a variety of shapes that can result from press molding in a flexible manner at low costs.

In the case of a soft magnetic metal powder for a dust core, an insulating coat is formed on the surface of a soft magnetic metal powder particle such that not only powder insulation properties but also insulation properties of a dust core itself can be secured, resulting in inhibition of the occurrence of iron loss. Specifically, iron powder particles are covered with a silicone resin or an epoxy resin. In such case, in order to prevent film destruction upon press molding and secure insulation between iron powder particles, the amount of resin added to an iron powder is increased, for example.

FIGS. 11a to 11c show experimental results obtained by the present inventors for the relationships between the amount of resin added and specific resistance, the relationship between the same and strength, and the relationship between the same and density, respectively. In the above experiments, a flake iron powder containing, as a main component, iron and Si (1% by weight) and having an aspect ratio of 6 was used. As is apparent from FIGS. 11a and 11b, an increase in the amount of resin added causes an increase in specific resistance (resulting in the improvement of insulating properties), leading to the improvement of dust core strength. However, as is apparent from FIG. 11c, an increase in the resin proportion in an iron powder causes a decrease in dust core density. Such decrease in density causes reduction in the magnetic flux density (magnetic properties) of the dust core.

In addition, there is a method for producing a dust core that comprises press-molding a magnetic powder comprising a silicone resin preliminarily condensed on the surfaces of iron powder particles. However, in this method, gaps tend to be generated between magnetic powder particles, resulting in reduction in dust core strength. Also, there is a method for producing a dust core that comprises press-molding a magnetic powder comprising a silica film preliminarily formed on the surfaces of iron powder particles. In this method, since a silica film is an inorganic insulating material, magnetic powder particles are merely interlocked with each other for binding therebetween, which inevitably results in reduction in the dust core strength.

Therefore, it is an urgent object to produce and develop a dust core having excellent insulating properties, high strength, and high density.

For example, Patent Documents 1 to 3 disclose conventional methods for producing a dust core. Patent Document 1 discloses a method for producing a dust core wherein the surfaces of iron powder particles are treated with a dispersant, and a silicone resin or the like is mixed therewith, followed by press molding and heat treatment. Patent Documents 2 and 3 disclose methods for producing a dust core wherein a pure iron powder or a pure iron powder comprising particles each having a phosphate film on the surface thereof is mixed with poly(phenylene sulfide) (PPS) or thermoplastic polyimide (PI), followed by press molding and heat treatment.

When the production method in Patent Document 1 is used to produce a dust core, it is impossible to solve the above problem of reduction in dust core density. When the production methods in Patent Documents 2 and 3 are used, PPS or PI softened by heat treatment is unlikely to fill gaps between powder particles, and thus it is impossible to solve the above problem of reduction in dust core density.

### Patent Document 1:

JP Patent Publication (Kokai) No. 11-126721 A (1999)

### Patent Document 2:

JP Patent Publication (Kokai) No. 2002-246219 A

### Patent Document 3:

JP Patent Publication (Kokai) No. 2006-310873 A

### DISCLOSURE OF THE INVENTION

The present invention has been made in view of the above problems. It is an object of the present invention to provide a dust core having excellent insulating properties, high strength, and high density (high magnetic flux density), a method for producing the same, and an electric motor or reactor having a core member composed of the dust core.

In order to achieve the above object, the method for producing a dust core of the present invention comprises at least the following steps: a 1^{St} step of preparing a resin powder and a magnetic powder comprising soft magnetic metal powder particles each having an insulating film preliminarily formed on the surface thereof; a 2^{nd} step of obtaining a powder mixture by mixing the magnetic powder and the resin powder; and a 3^{rd} step of allowing the resin powder to gel in an atmosphere at a certain temperature and press-molding the powder mixture so as to produce a dust core that is obtained as a press molded body.

Herein, examples of a soft magnetic metal powder that can be used include powders made from pure iron, iron-silicone based alloys, iron-nitrogen based alloys, iron-nickel based alloys, iron-carbon based alloys, iron-boron based alloys, iron-cobalt based alloys, iron-phosphorus based alloys, iron-nickel-cobalt based alloys, and iron-aluminium-silicone based alloys. In addition, examples of an insulating film that can be used include films comprising silica (SiO₂), inorganic materials such as nitride film (Si₃N₄), and ceramic materials. However, the present invention is not limited by such examples as long as the material used has a melting point exceeding the temperature upon warm molding and does not gel upon warm molding.

Further, examples of a resin powder that can be used include a silicone resin, an epoxy resin, a phenol resin, a polyester resin, a polyamide resin, and a polyimide resin each in a powder form.

In the method for producing a dust core of the present invention, an insulating film is preliminarily formed on the surfaces of the above soft magnetic metal powder particles. A magnetic powder comprising particles coated with the insulating film is prepared. Herein, an example of a method for forming such an insulating film is a method wherein the surfaces of particles of a soft magnetic metal powder comprising pure iron or the like are siliconized with Si at a high concentration by use of a decarbonization/reduction reaction, followed by oxidization (corresponding to the 1^{st} step).

Next, a powder mixture is prepared by mixing the thus formed magnetic powder and the above resin powder. The obtained powder mixture is placed in a certain high-temperature atmosphere such that the resin powder alone is allowed to gel. The powder mixture comprising the resin powder in a gel form is press-molded in a molding die having a certain shape such that gaps between magnetic powder particles coated with a hard insulating film are filled with gel-like resin particles.

According to the above production method, it is possible to increase the density of a produced dust core to a greater extent than that obtained by a conventional production method wherein a soft magnetic metal powder comprising a relatively large amount of resin formed on the surfaces of soft magnetic metal powder particles is press-molded. The realization of such high density leads to the improvement of the magnetic flux density of the dust core. Herein, a dust core with a high density can be obtained for the reasons described below. That is, the object of a conventional method is to form an insulating layer with resin particles. Therefore, in order to secure excellent insulating properties, large amounts of resin particles are used such that the resin particle proportion in a dust core increases, resulting in reduction in the density of the dust core. Meanwhile, according to the production method of the present invention, an insulating film is preliminarily formed on the surfaces of soft magnetic metal powder particles. Therefore, resin particles are mixed with magnetic powder particles to function as binders for binding the magnetic powder particles and thus not to be used for securing insulating properties. Accordingly, the necessary resin amount corresponds to an amount sufficient to fill gaps between magnetic powder particles.

In addition, the strength of a produced dust core can be improved as a result of binding of magnetic powder particles via a resin binder. The present inventors verified the following facts. According to the above conventional production method, the dust core strength deteriorates due to gaps generated between magnetic powder particles upon press molding. However, according to the production method of the present invention, the entire portion of a magnetic powder is press-molded under a condition in which gaps between magnetic powder particles are filled with gel-like resin particles. Thus, strong binding is achieved via a high binding force to which the adhesion force exhibited by a resin binder is added in addition to the interlocking force between magnetic powder particles. In addition, the dust core strength can be defined based on bending strength, tensile strength, radial crushing strength, or the like.

Herein, a condition in which resin particles are allowed to gel refers to a condition in which resin particles have viscosity characteristics that result in viscosity lower than a viscosity of 10000 Pa·s (Pascal second), at which the glass flow temperature is defined. In general, the resin particle viscosity is approximately 5000 Pa·s or lower.

Consequently, according to the method for producing a dust core of the present invention, it has become possible to produce a dust core having excellent strength properties and magnetic properties while securing insulating properties.

In addition, in one preferable embodiment of the method for producing a dust core of the present invention, the above press molded body is preferably annealed in the 3^{rd} step. In such case, a silica film is formed with a resin added as a binder such that insulating properties are secured. Further, annealing results in elimination of processing strains generated in the dust core as a result of press molding. Thus, reduction in magnetic properties due to press molding can be prevented.

In another embodiment of the method for producing a dust core of the present invention, the above 3^{rd} step is characterized by warm molding involving filling of a molding die with a powder mixture and press molding of the powder mixture in an atmosphere at a temperature at which the resin powder is not condensation-polymerized.

Warm molding refers to a molding method wherein a powder and a molding die (mold) are heated in an atmosphere at a temperature of approximately 100° C. to 150° C. and subjected to press molding during heating. In such temperature range, a silicone resin is not condensation-polymerized, for example.

Resin particles are formed into a gel in an atmosphere at a temperature for the above warm molding, that is to say, a temperature at which a resin is not condensation-polymerized or a temperature that is lower than the temperature for condensation polymerization of the resin. As described above, gaps between magnetic powder particles can be filled with the gel-like resin particles.

In addition, when the resin particles used are silicone resin particles that are specified as those commercially available such as YR3370 (produced by GE Toshiba Silicones Co., Ltd.) and the KR series (KR221, 240, 220L, etc.) (produced by Shin-Etsu Chemical Co., Ltd.), the temperature at the above 3^{rd} step (i.e., the temperature for warm molding) is preferably set to approximately 120° C. to 145° C. Such commercially available silicone resins (powders) can be purchased at popular prices and thus dust cores can be produced at lower costs.

In addition, the dust core of the present invention is a dust core obtained in a manner such that a resin is used to fill gaps between magnetic powder particles comprising soft magnetic metal powder particles each having an insulating film preliminarily formed on the surface thereof, followed by curing. It is characterized in that the proportion of the resin mixed is 0.3% by weight or less, the magnetic flux density (B50) is 1.4 T (tesla) or more, and the radial crushing strength is 70 MPa or more.

In the cases of dust cores produced by conventional production methods, when it is attempted to improve insulating properties, it is inevitable to increase the amount of a resin. When the resin proportion in a dust core is increased, the dust core density decreases. Such a decrease in the dust core density directly causes a decrease in the magnetic flux density. On the other hand, when it is attempted to increase the dust core magnetic flux density, it is necessary to decrease the amount of a resin. As a result, sufficient adhesion force cannot be obtained using a decreased amount of a resin binder. Thus, dust core strength properties such as radial crushing strength are reduced. Therefore, dust cores produced by conventional production methods do not have excellent strength properties and excellent magnetic properties (e.g., magnetic flux density). In addition, the present inventors have demonstrated the following facts by experiments. In the cases of conventional dust core production methods, the radial crushing strength obtained is approximately 30 MPa at maximum when it is attempted to increase the magnetic flux density (B50) to 1.4 T or more, while on the other hand, the radial crushing strength obtained is approximately 50 MPa at maximum when it is attempted to suppress the magnetic flux density (B50) to approximately 1.2 T.

Unlike the above dust cores produced by conventional methods, a dust core obtained by the production method of the present invention described above has properties expressed by a magnetic flux density (B50) of 1.4 T or more and a radial crushing strength of 70 MPa or more and thus it has excellent strength properties and excellent magnetic properties.

Herein, it is preferable to use silica (SiO₂) for an insulating film that constitutes a dust core having the above properties and to use a silicone resin as the above resin in view of production costs and the like.

Further, the amount of resin added when a dust core having the above properties is formed is adjusted to approximately 0.3% by weight or less. Experiments conducted by the present inventors demonstrated that the highest radial crushing strength can be obtained at a proportion of resin added of approximately 0.2% by weight, and that the magnetic flux density gradually decreases as a result of an increase in the proportion of resin added. In view of the experimental results, it is reasonable to set the proportion of resin added to approximately 0.3% by weight or less as described above and preferably 0.1% to 0.3% by weight in order to obtain a dust core having a magnetic flux density (B50) of 1.4 T or more and a radial crushing strength of 70 MPa or more. In addition, the aspect ratio of a soft magnetic metal powder to be used can be set to approximately 1 to 10, and the average particle size of the powder can be set to approximately 150 to 200 μm.

The above dust core having high strength and high magnetic flux density is used for a stator core and/or a rotor core for production of an electric motor. The thus obtained electric motor is preferably used for hybrid vehicles, electric vehicles, and the like, which require a driving electric motor having excellent magnetic properties and excellent strength properties.

Similarly, when the above dust core of the present invention is used for a reactor core, such a reactor core is preferably used for a reactor that is installed in hybrid vehicles, electric vehicles, and the like.

As is understood based on the above descriptions, a dust core having high strength and high magnetic flux density while securing insulating properties can be produced by the method for producing a dust core of the present invention. In addition, the dust core of the present invention has excellent strength properties and magnetic properties represented by a magnetic flux density (B50) of 1.4 T or more and a radial crushing strength of a 70 MPa, respectively.

### BRIEF DESCRIPTION OF THE DRAWINGS

FIG. 1 is an explanatory drawing of the temperature range for a silicone resin in a solid, gel, or condensation-polymerized form.

FIGS. 2a to 2e each show an explanatory drawing of a step of the method for producing a dust core of the present invention.

FIG. 3 is an enlarged view of III in FIG. 2a.

FIG. 4 is an enlarged view of IV in FIG. 2b.

FIG. 5 is an enlarged view of V in FIG. 2d.

FIG. 6 is a graph showing the gelling temperature range for a silicone resin.

FIG. 7 is a graph showing experimental results for the relationship between the radial crushing strength and the amount of resin added for the dust core of the present invention (Example) and for the dust core obtained in the Comparative Example.

FIG. 8 is a graph showing experimental results for the relationship between the magnetic flux density and the amount of resin added for the dust core of the present invention (Example) and for the dust core obtained in the Comparative Example.

FIG. 9 is a graph showing experimental results for strength properties and magnetic properties of the dust core of the present invention (Example) and of the dust cores obtained in the Comparative Examples.

FIG. 10 is a graph showing calculation results for the aspect ratio of a soft magnetic metal powder, the amount of resin mixed, and the average particle size.

FIG. 11 (a) is a graph showing the relationship between the amount of resin added and the specific resistance for an iron powder with an Fe-1Si composition and an aspect ratio of 6. FIG. 11 (b) is a graph showing the relationship between the amount of resin added and the strength. FIG. 11 (c) is a graph showing the relationship between the amount of resin added and the density.

In the drawings, the numerical reference 1 denotes a magnetic powder, the numerical reference 11 denotes a pure iron powder (soft magnetic metal powder), the numerical reference 12 denotes a silica film (insulating film), the numerical reference 2 denotes a silicone resin powder (resin powder), the numerical reference 2A denotes a gel-like resin, the numerical reference 10 denotes a press-molded body, and the numerical reference 20 denotes a dust core.

### BEST MODE FOR CARRYING OUT THE INVENTION

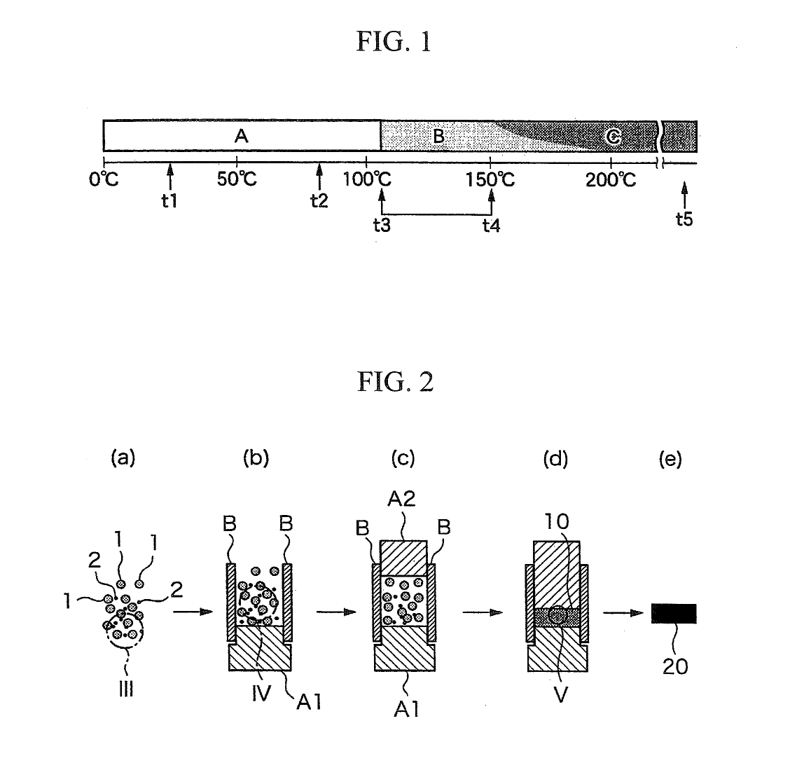

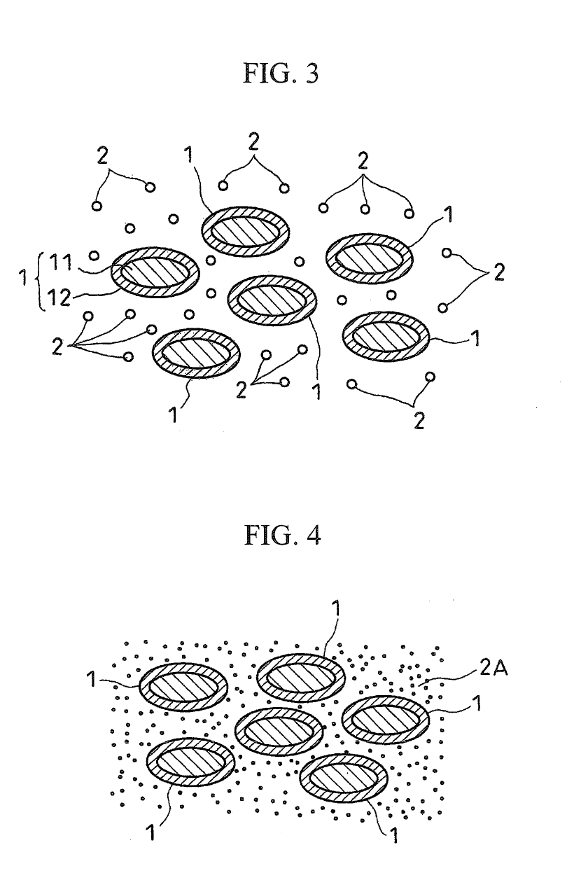

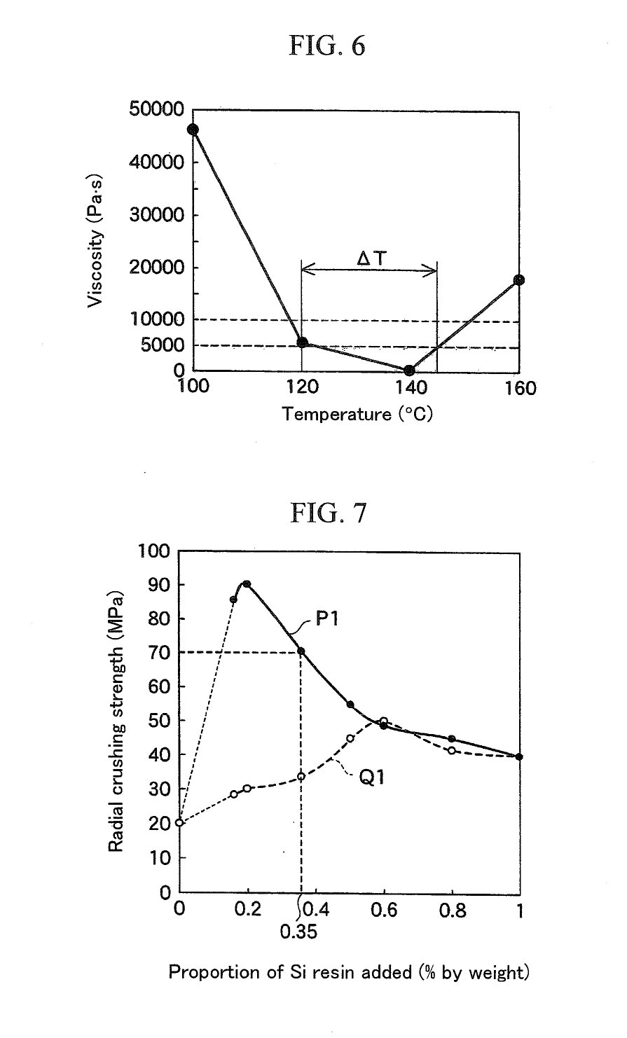

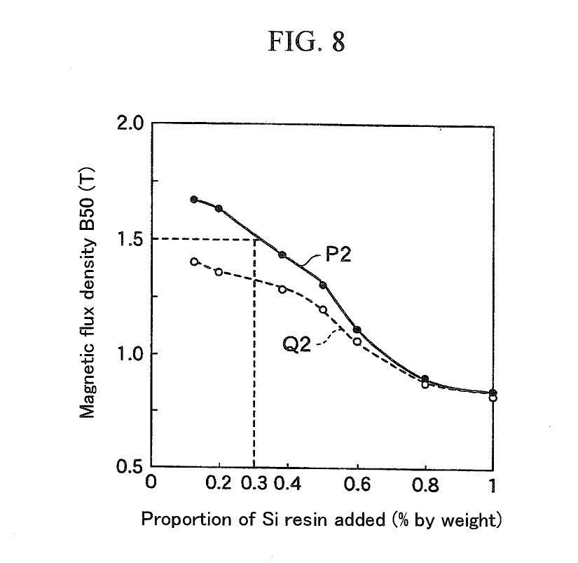

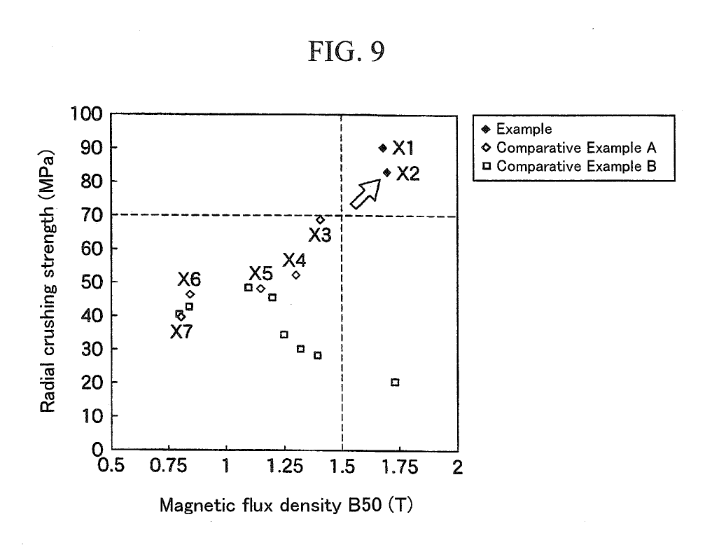

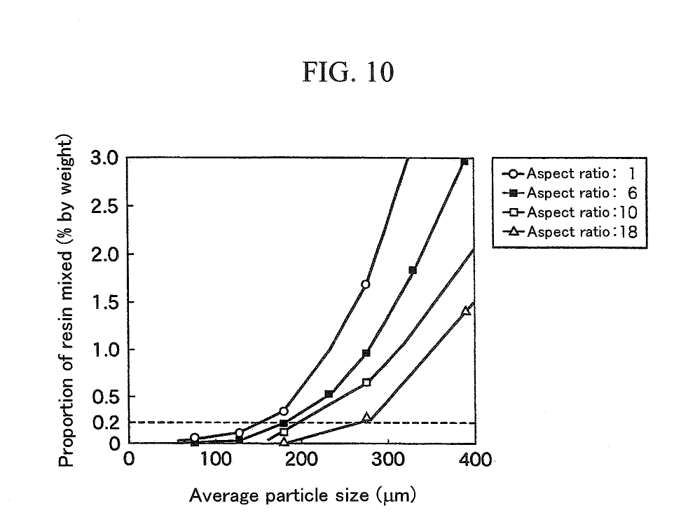

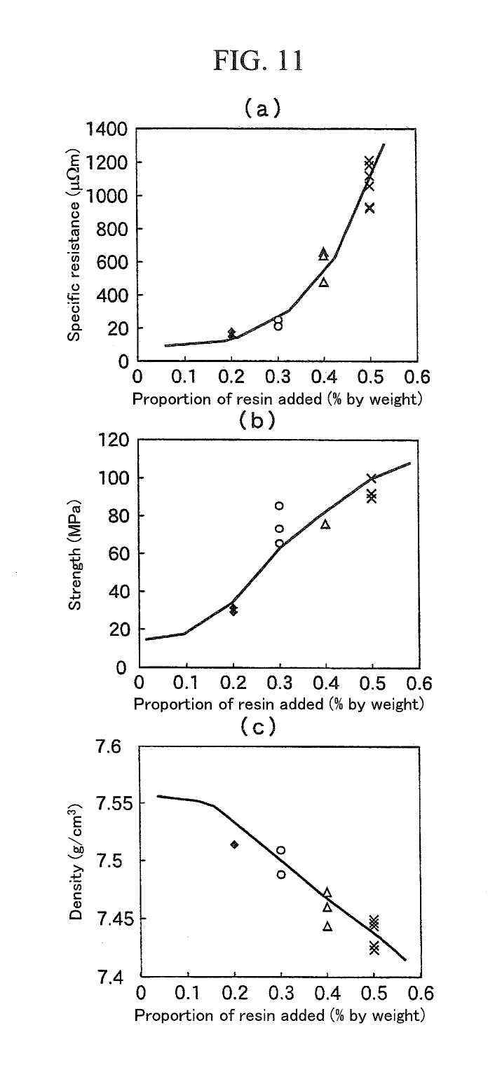

Hereinafter, embodiments of the present invention are described with reference to the drawings. FIG. 1 is an explanatory drawing of the temperature range for a silicone resin in a solid, gel, or condensation-polymerized form. FIGS. 2a to 2e each show an explanatory drawing of a step of the method for producing a dust core of the present invention. FIGS. 3 to 5 are enlarged views of III, IV, and V in (a), (b), and (d) in FIG. 2, respectively. FIG. 6 is a graph showing the gelling temperature range for a silicone resin. FIG. 7 is a graph showing experimental results for the relationship between the radial crushing strength and the amount of resin added for the dust core of the present invention (Example) and for the dust core obtained in the Comparative Example. FIG. 8 is a graph showing experimental results for the relationship between the magnetic flux density and the amount of resin added for the dust core of the present invention (Example) and for the dust core obtained in the Comparative Example. FIG. 9 is a graph showing experimental results for strength properties and magnetic properties of the dust core of the present invention (Example) and of the dust cores obtained in the Comparative Examples. FIG. 10 is a graph showing calculation results for the aspect ratio and the average particle size of a soft magnetic metal powder in relation to the necessary amount of resin mixed for filling gaps between magnetic powder particles.

First, the method for producing a dust core of the present invention is described in detail with reference to FIGS. 1 to 5. In addition, regarding a magnetic powder of interest, pure iron is used for a soft magnetic metal powder. An insulating film preliminarily formed on powder particle surfaces comprises silica (SiO₂). A resin used for filling gaps between magnetic powder particles is a silicone resin.

FIG. 1 is an explanatory drawing of the temperature range for a silicone resin in a solid, gel, or condensation-polymerized form (corresponding to region A, B, or C, respectively, in the figure). The temperature at which a silicone resin exists in a gel form substantially corresponds to the temperature for warm molding. It ranges from approximately 120° C. to approximately 145° C. (t3 to t4).

FIGS. 2a to 2e each show an explanatory drawing of a step of the method for producing a dust core of the present invention. FIG. 2a explains a condition in which a magnetic powder 1 is mixed with a silicone resin powder 2 at an ordinary temperature. Specifically, a powder mixture is formed by a method of agitating and mixing a magnetic powder and a given amount of a silicone resin powder or a method of uniformly mixing a silicone resin powder 2 with a magnetic powder 1 by mixing both powders at a temperature close to t1 in FIG. 1 and volatilizing a solvent at a temperature closed to t2 in FIG. 1. Herein, YR3370 (Produced by GE Toshiba Silicones Co., Ltd.), which is relatively cost-effective compared with other similar materials, can be used as a silicone resin powder 2.

FIG. 3 shows an enlarged view of III in FIG. 2a. As shown in the figure, a magnetic powder 1 is obtained by forming a silica film 12 over the surfaces of particles of a pure iron powder 11. The magnetic powder 1 is prepared in advance in the previous step. Specifically, a pure iron powder 11 is siliconized with Si at a high concentration by use of a decarbonization/reduction reaction, followed by oxidization. Accordingly, a hard silica film having excellent insulating properties is formed over the surfaces of particles of the pure iron powder 11.

Referring back to FIG. 2b, a powder mixture comprising a magnetic powder 1 and a silicone resin powder 2 is loaded into a space formed with a periphery mold B and a lower punch A1. After loading of the powder mixture, an upper punch A2 is used to close the space as shown in FIG. 2c, followed by pressurization on the upper punch A2 at a given pressure as shown in FIG. 2d. Accordingly, a press molded body 10, which is an intermediate molded body of a dust core, is molded.

Herein, the steps in FIGS. 2b to 2d correspond to warm molding steps, which are carried out in an atmosphere at a temperature (t3 to t4) shown in FIG. 1.

FIG. 4 shows an enlarged view of IV in FIG. 2b. In an atmosphere at a temperature of 100° C. to 150° C. and particularly of 120° C. to 145° C., a silicone resin powder 2 in a powder mixture alone is allowed to gel such that a gel-like resin 2A is formed. FIG. 6 shows experimental results obtained by the present inventors regarding the silicone resin gelling temperature range. Based on FIG. 6, it has been found that, when YR3370 is used as a silicone resin, the gelling temperature ranges from approximately 120° C. to 145° C., and that the viscosity of the silicone resin is approximately 5000 Pa·s or less in such temperature range. In addition, a dashed line in the figure represents the viscosity based on which the glass flow temperature is defined. Such viscosity is approximately 10000 Pa·s. Therefore, in a case in which the degree of silicone resin gelling is defined based on such viscosity, the viscosity is approximately 10000 Pa·s at maximum. In general, a gel-like silicone resin is specified to have viscosity properties corresponding to a viscosity of approximately 5000 Pa·s.

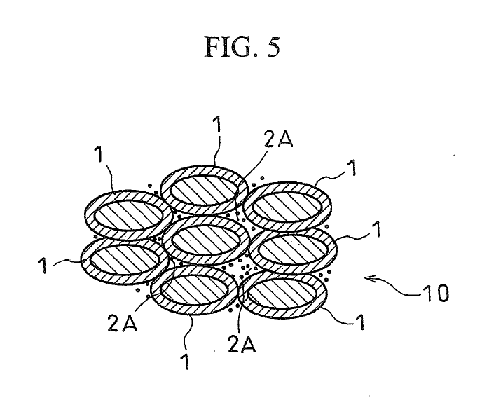

When the silicone resin powder 2 in the powder mixture contained in the molding die is formed into a gel-like resin 2A, press molding is carried out as shown in FIG. 2d. Accordingly, as shown in FIG. 5, which is an enlarged view of V, gaps between particles of the magnetic powder 1 are filled with the gel-like resin 2A, followed by curing. Thus, a press molded body 10 is formed.

At the end, the press molded body 10 is annealed in an atmosphere at a temperature of approximately 600° C. to 750° C., which corresponds to the temperature (t5) in FIG. 1. Thus, a dust core 20 having a desired shape that is free from processing strains can be obtained. The above annealing causes condensation polymerization of a gel-like silicone resin. As a result, strong binding between particles of the magnetic powder 1 can be achieved due to the inter-particle interlocking force and the adhesion force exhibited by the silicone resin.

[Experiments for strength properties and magnetic properties of the dust core (Example) of the present invention and the dust cores obtained in the Comparative Examples and the experimental results]

The present inventors used a pure iron powder as a soft magnetic metal powder. A magnetic powder was prepared by forming a silica film (an oxide of a silicone resin (YR3370)) over the surfaces of particles of the pure iron powder. The magnetic powder was mixed with a silicone resin in a manner such that the resulting mixture contained 0.2% by weight of the silicone resin added. Thus, a powder mixture was formed. Then, the silicone resin was allowed to gel in accordance with the above method, followed by press molding and annealing. Accordingly, a dust core was molded (Example). Meanwhile, two dust cores were molded by a conventional production method in the Comparative Examples. One of them (Comparative Example 1) was obtained by simply press-molding a magnetic powder comprising pure iron particles each having a silica thin film preliminarily formed on the surface thereof. The other one (Comparative Example 2) was obtained by press-molding a pure iron powder comprising particles coated with a relatively large amount of an Si resin. Table 1 below lists measurement values in terms of density, eddy loss, strength (radial crushing strength), and magnetic flux density B50 in the Example and Comparative Examples 1 and 2. In addition, FIG. 7 shows experimental results for the relationship between the radial crushing strength and the amount of silicone resin added. FIG. 8 shows experimental results for the relationship between the magnetic flux density B50 and the amount of silicone resin added. FIG. 9 is a graph showing experimental results for radial crushing strength and magnetic flux density B50.

In addition, in the method for measuring the radial crushing strength, a ring-shaped dust core test piece with a thickness of 5 mm, an outside diameter of 39 mm, and an inside diameter of 30 mm was produced. The radial crushing strength was determined with an applied pressure at which cracks were generated in the test piece as a result of pressurization with a compressor.

TABLE 1

| | | | | Radial | Magnetic |
|---|---|---|---|---|---|
| | Film | | Eddy | crushing | flux density |
| | thickness | Density | loss | strength | (B50) |
| | (μm) | (g/cm³) | (W/kg) | (MPa) | (T) |
| Example | ≦0.1 | 7.72 | 16 | 90 | 1.64 |
| Comparative | ≦0.1 | 7.73 | 16 | 20 | 1.65 |
| Example 1 | | | | | |
| Comparative | ≧0.5 | 7.5-7.6 | 14 | 30 | 1.35 |
| Example 2 | | | | | |

As shown in table 1, in the case of Comparative Example 2, the amount of silicone resin increased and thus the resin film thickness on the surface of a pure iron powder particle increased. As a result, the density decreased to a greater extent than that in the Example and that in Comparative Example 1. Also, the magnetic flux density decreased.

In the case of Comparative Example 1, magnetic flux density comparable to that in the Example was obtained. However, the radial crushing strength significantly decreased to a level corresponding to 20% of that in the Example. The reason why the strength in Comparative Example 1 decreased to a greater extent than that in Comparative Example 2 is that an adhesion force was additionally exhibited by a resin binder upon binding between magnetic powder particles in Comparative Example 2.

In the case of the Example, the magnetic flux density (B50) was observed to reach a level as high as 1.4 T or higher compared with Comparative Examples 1 and 2. Also, the radial crushing strength was observed to reach a level as high as 70 MPa or higher. Thus, it is understood that the dust core obtained in the Example has excellent strength properties and excellent magnetic properties.

In addition, based on the results for the relationship between the radial crushing strength and the amount of resin added in the Example (line P1 in the graph) and in Comparative Example 2 (line Q1 in the graph) shown in FIG. 7, the radial crushing strength obtained in Comparative Example 2 was found to reach a peak value of approximately 50 MPa at maximum, regardless of the amount of silicone resin added. On the other hand, in the Example, high radial crushing strength was obtained with a content of silicone resin added of approximately 0.2% to 0.35% by weight. In particular, it was demonstrated that it was possible to obtain a strength as high as 90 MPa with a content of silicone resin added of approximately 0.2% by weight.

In addition, based on the results for the relationship between the magnetic flux density B50 and the amount of silicone resin added in the Example (line P2 in the graph) and in Comparative Example 2 (line Q2 in the graph) shown in FIG. 8, the density was found to decrease as a result of an increase in the amount of silicone resin added in both cases. Also, the magnetic flux density tended to gradually decrease as a result of decrease in density. However, in the case of the Example, it is understood that a magnetic flux density (B50) of 1.4 T or more can be obtained with a content of silicone resin added of 0.3% by weight or less.

Based on the experimental results shown in FIGS. 7 and 8, it is possible to conclude that a dust core is preferably produced by the production method of the present invention, and that the content of silicone resin added is predetermined at preferably 0.1% by weight to 0.3% by weight (provided that the radial crushing strength is approximately 60 MPa based on FIG. 7).

FIG. 9 is a graph created by combining the results in FIG. 7 and those in FIG. 8. The vertical axis represents the radial crushing strength and the horizontal axis represents the magnetic flux density. In FIGS. 9, X1 and X2 represent results for dust cores obtained in the Example with the above preferable amount of silicone resin added. X3 to X7 represent results for dust cores obtained in Comparative Example A according to the production method of the present invention, provided that the amount of silicon resin added did not fall within the above preferable range of the amount of silicone resin added. Further, Comparative Example B corresponds to a dust core obtained in Comparative Example 2 described above.

Based on FIG. 9, it is revealed that a dust core having excellent strength properties and excellent magnetic properties can be obtained by using the production method of the present invention and predetermining the amount of silicone resin added within the above given range.

FIG. 10 shows results for the relationship between the amount of resin added and the average magnetic powder particle size obtained by calculation with a different aspect ratio of 1 to 18. In general, a soft magnetic metal powder with an aspect ratio of approximately 1 to 6 is used. However, it was demonstrated that the average particle size of a magnetic powder becomes approximately 150 to 200 μm in the above case with a preferable content of resin added of 0.2% by weight.

The dust core of the present invention described above has excellent strength properties and excellent magnetic properties. Thus, the dust core of the present invention is particularly preferably used for a stator core, a rotor core, or a reactor core for a reactor used in electric motors for vehicles such as hybrid vehicles that need to be durable in significantly changing environments and downsized while achieving high performance.

Embodiments of the present invention are described above with reference to the drawings. However, the specific constitution of the present invention is not limited to the embodiments. Therefore, the present invention encompasses any design changes or the like that do not depart from the spirit of the present invention.

1. A method for producing a dust core, comprising at least the following steps:
a 1^{st} step of preparing a resin powder and a magnetic powder comprising soft magnetic metal powder particles each having an insulating film preliminarily formed on the surface thereof;
a 2^{nd} step of obtaining a powder mixture by mixing the magnetic powder and the resin powder; and
a 3^{rd} step of allowing the resin powder to gel in an atmosphere at a certain temperature and press-molding the powder mixture so as to produce a dust core that is obtained as a press molded body.

2. The method for producing a dust core according to claim 1, wherein the press molded body is annealed in the 3^{rd} step.

3. The method for producing a dust core according to claim 1, wherein the 3^{rd} step is characterized by warm molding involving filling of a molding die with the powder mixture and press molding of the powder mixture in an atmosphere at a temperature at which the resin powder is not condensation-polymerized.

4. The method for producing a dust core according to claim 1, wherein the resin powder comprises a silicone resin and the temperature is 110° C. to 150° C. in the atmosphere in the 3^{rd} step.

5. A dust core, which is obtained in a manner such that a resin is used to fill gaps between magnetic powder particles comprising soft magnetic metal powder particles each having an insulating film preliminarily formed on the surface thereof, followed by curing, characterized in that the proportion of the resin mixed is 0.3% by weight or less, the magnetic flux density (B50) is 1.4 T or more, and the radial crushing strength is 70 MPa or more.

6. The dust core according to claim 5, in which the insulating film comprises silica (SiO₂) and the resin comprises a silicone resin.

7. An electric motor, in which a stator core and/or a rotor core is composed of the dust core according to claim 5.

8. A reactor, in which a reactor core is composed of the dust core according to claim 5.
